(19) United States
(12) Patent Application Publication
(10) Pub. No.: US 2025/0266951 A1
(43) Pub. Date: Aug. 21, 2025

(54) SYSTEMS AND METHODS FOR DYNAMIC DEMODULATION REFERENCE SIGNAL CONFIGURATION

(71) Applicant: HFCL Limited, Bangalore (IN)

(72) Inventors: Subhas Chandra MONDAL, Bangalore (IN); Amartya DAS, Bangalore (IN); Praveen S, Bangalore (IN)

(21) Appl. No.: 19/054,075

(22) Filed: Feb. 14, 2025

(30) Foreign Application Priority Data
Feb. 16, 2024 (IN) IN202441011007

(51) Int. Cl. H04L 5/00; H04W 72/21; H04W 72/23; H04W 72/51

(52) U.S. Cl. CPC H04L 5/0048; H04L 5/0005; H04W 72/21; H04W 72/23; H04W 72/51

(57) ABSTRACT

Systems and methods for dynamic Demodulation Reference Signal (DMRS) configuration described. An adaptive DMRS configuration based channel condition variation is described, where the allocation of DMRS in both time and frequency domain is dynamically configured based on a condition of a channel between a base station and a user equipment (UE). The number of DMRS Resource Elements (REs) present in the frequency domain in a Resource Block (RB) and the position of the DMRS within the RB are varied dynamically. Based on this dynamic configuration, two configuration types for DMRS for the frequency domain allocation of DMRS are described. The DMRS in the time domain is varied in a similar way, where DMRS REs are punctured for specific slots based on the channel conditions.

### TECHNICAL FIELD

The present disclosure, in general, relates to wireless communication systems. In particular, the present disclosure relates to a method and a system for efficient and dynamic Demodulation Reference Signal (DMRS) configuration.

### BACKGROUND

Channel estimation is an intricate method employed to deduce the stochastic properties of a communication channel. Within the context of wireless communication and especially telecommunication, the process of channel estimation is facilitated through the utilization of reference signals. The 5G framework encompasses multiple reference signals designed to enable channel estimation for both uplink (UL) and downlink (DL) communication pathways. In the DL scenario, the channel state information reference signal (CSI-RS) is harnessed to ascertain and communicate the prevailing channel conditions to the gNodeB (gNB). Conversely, in the UL scenario, if the sounding reference signal (SRS) is configured, the channel estimation can be performed accurately. These two reference signals are transmitted prior to the commencement of actual data transmission, serving the purpose of quantifying channel quality. This assessment of channel quality subsequently informs the selection of the optimal modulation and coding scheme (MCS).

To ensure accurate and coherent demodulation of transmitted data on the recipient end, an integral component is the transmission of a demodulation reference signal (DMRS) concurrently with the data. This DMRS is strategically utilized by the receiver to undertake channel estimation and subsequently demodulate the conveyed data. The DMRS is purposefully allocated across various physical layer channels, encompassing the physical downlink control channel (PDCCH), physical downlink shared channel (PDSCH), physical uplink control channel (PUCCH), physical uplink shared channel (PUSCH), and physical broadcast channel (PBCH).

The major drawback of the existing technology is that even if the channel conditions are varying slowly (for example when being an indoor scenario where user equipment are moving very slowly), at least 4 DMRS Resource Elements (REs) per Resource Block (RB) needs to be transmitted in the frequency domain. This adds an overhead of around 5% for every timeslot.

Therefore, there is a well-established need to optimize this signalling overhead by reducing the DMRS efficiently. Further, in the existing systems, at least one symbol in every slot allocated to PDSCH/PUSCH should carry the DMRS, which can be further reduced for slow varying channel conditions.

Further, in the existing systems, the location of the DMRS is fixed and cannot be varied. This may impact the channel estimation if the channel exhibits frequency selective fading as a function of time where the REs allocated for the DMRS are impacted by various channel and system impairments caused by various sources e.g. a moving object between the transmitter and the receiver, a reflecting surface, etc.

Therefore, there is, a need for a system and a method for efficient and dynamic DMRS configuration.

### OBJECTS OF THE PRESENT DISCLOSURE

It is an object of the present disclosure to provide a system and a method for efficient and adaptive Demodulation Reference Signal (DMRS) configuration.

It is an object of the present disclosure to provide a system and a method for dynamic DMRS configuration based on adaptive channel conditions.

It is an object of the present disclosure to provide a system and a method for dynamic DMRS configuration in frequency domain and time domain.

### SUMMARY

In an aspect, the present disclosure relates to a method for dynamic Demodulation Reference Signal (DMRS) configuration, including determining, by a base station, a condition of a channel between the base station and a User Equipment (UE), determining, by the base station, a configuration type from a plurality of DMRS configuration types based on the condition of the channel, wherein each DMRS configuration from the plurality of DMRS configuration types has a different number of resource elements allocated for transmitting a DMRS in an uplink signal or a downlink signal, and transmitting, by the base station, an indicator signal to the UE to indicate a position of one or more resource elements of at least one resource block forming a resource block group allocated for the DMRS in the uplink signal or downlink signal.

In an embodiment, the method may include transmitting, by the base station, the downlink signal with the DMRS configured at the allocated position of the one or more resource elements.

In an embodiment, the method may include transmitting, by the base station, a UE enquiry signal, and receiving, by the base station, a UE capability information signal comprising data on capabilities of the UE, where the one or more resource elements for the DMRS may be allocated based on the capabilities of the UE.

In an embodiment, allocating the one or more resource elements for the DMRS may include transmitting, by the base station, a Channel State Information-Reference Signal (CSI-RS) to the UE, receiving, by the base station, a CSI report from the UE in response to the CSI-RS, and determining, by the base station, the condition of the channel based on at least the CSI report, where the one or more resource elements may be allocated based on the condition of the channel.

In an embodiment, the method may include allocating, by the base station, a first set of resource elements in the downlink signal for the DMRS, where the indicator signal may indicate positions of the first set of resource elements having the DMRS in the downlink signal.

In an embodiment, the method may include allocating, by the base station, a second set of resource elements in the uplink signal for the DMRS, where the indicator signal may indicate positions of the second set of resource elements for the DMRS in the uplink signal from the UE.

In an embodiment, the method may include receiving, by the base station, the uplink signal from the UE having the DMRS in the second set of resource elements.

In an embodiment, the indicator signal may be any one or a combination of: Radio Resource Control (RRC) messages, or Media Access Control (MAC) control elements.

In an embodiment, the indicator signal may include any one or a combination of: the position of the one or more resource elements allocated for the DMRS in the downlink signal or the uplink signal, a number of the one or more resource elements allocated for the DMRS, a start position of the resource block, an end position of the resource block, and a frequency of the one or more resource elements.

In an embodiment, the method may include allocating, by the base station, based on an uplink threshold and a downlink threshold, one of: one resource element of the at least one resource block for the DMRS in the downlink signal and the uplink signal when the condition of the channel is constant over a configured bandwidth, two resource elements of the at least one resource block for the DMRS in the downlink signal and the uplink signal based on a change in the condition of the channel over the configured bandwidth, one resource element of the at least one resource block for the DMRS in the downlink signal, and two resource elements of the at least one resource block for the DMRS for the uplink signal, or two resource elements of the at least one resource block for the DMRS in the downlink signal and one resource element of the at least one resource block for the DMRS in the uplink signal.

In an embodiment, the method may include allocating, by the base station, the one or more resource elements in a frequency domain based on the condition of the channel, where allocating the one or more resource elements in the frequency domain may include determining, by the base station, the position and a frequency of the one or more resource elements based on any one or a combination of: Channel Quality Indicator, Reference Signal Received Power (RSRP), Reference Signal Received Quality (RSRQ), signal-to-noise ratio, number of antenna ports associated with the base station, Hybrid Automatic Repeat Request (HARQ) feedback, cell throughput, and timing advance values transmitted to the UE of a preceding time interval of a predetermined duration.

In an embodiment, the method may include allocating, by the base station, the one or more resource elements for the DMRS in the at least one resource block forming the resource block group, where a number of resource blocks in the resource block group may be determined based on the condition of the channel.

In an embodiment, for non-contiguous physical uplink shared channel (PUSCH) allocation or physical downlink shared channel (PDSCH) allocation of the one or more resource elements for the DMRS, the method may include transmitting, by the base station, at least one of: a bitmap having one or more bits corresponding to the resource block group through the indicator signal, a value of each of the one or more bits in the bitmap indicating a presence of the DMRS in the resource block group, and a position parameter that indicates the position of the DMRS within each resource block in the resource block group having the DMRS.

In an embodiment, for contiguous PUSCH allocation or PDSCH allocation of the one or more resource elements for the DMRS, the method may include transmitting, by the base station, a start resource block in the resource block group, an end resource block in the resource block group, and a resource block frequency to indicate a location of the one or more resource elements having the DMRS.

In an embodiment, the method may include transmitting, by the base station, data or a null signal through a subset of resource elements from the one or more resource elements, based on at least one of: traffic load demand, channel conditions, and power constraints.

In another aspect, the present disclosure relates to a method for dynamic DMRS configuration, including determining, by a base station, a condition of a channel between the base station and a UE, determining, by the base station, a number of time slots to be associated with each DMRS in an uplink signal or a downlink signal based on the condition of the channel, transmitting, by the base station, an indicator signal to the UE to indicate the number of time slots to be associated with each DMRS in the uplink signal or the downlink signal, and transmitting, by the base station, the downlink signal to the UE with a DMRS in one or more time slots equal to the determined number of time slots.

In an embodiment, transmitting, by the base station, the downlink signal to the UE may include allocating, by the base station, the DMRS in a first time slot in the one or more time slots, and skipping, by the base station, allocation of the DMRS for subsequent time slots in the one or more time slots.

In an embodiment, determining, by the base station, the number of time slots to be associated with the DMRS may include determining, by the base station, a time coherence value based on at least one of: a center frequency, time advance values in a predetermined preceding interval, and a Block Error Rate (BLER).

In an embodiment, the indicator signal may be a downlink control indicator (DCI) message.

In another aspect, the present disclosure relates to a UE, including a processor, and a memory operatively coupled to the processor, wherein the memory includes processor-executable instructions which, when executed by the processor, cause the processor to receive an indicator signal from a base station, wherein the indicator signal indicates one of: a position of one or more resource elements of at least one resource block forming a resource block group allocated for a DMRS from a plurality of DMRS configuration types for a downlink signal or an uplink signal, or a total number of time slots to be associated with each DMRS in the downlink signal or the uplink signal, based on a condition of a channel between the UE and the base station, and transmit the uplink signal having the DMRS to the base station based on the indicator signal.

In an embodiment, the indicator signal may indicate the one or more resource elements allocated for the DMRS in the downlink signal or the uplink signal, based on a respective downlink threshold and an uplink threshold, from among one of: one resource element of the at least one resource block for the DMRS in the downlink signal and the uplink signal when the condition of the channel is constant over a configured bandwidth, two resource elements of the at least one resource block for the DMRS in the downlink signal and the uplink signal based on a change in the condition of the channel over the configured bandwidth, one resource element of the at least one resource block for the DMRS in the downlink signal, and two resource elements of the at least one resource block for the DMRS for the uplink signal, or two resource elements of the at least one resource block for the DMRS in the downlink signal and one resource element of the at least one resource block for the DMRS in the uplink signal.

In an embodiment, the UE may transmit data or a null signal through a subset of time slots from among the total number of time slots based on at least one of: traffic load demand, channel conditions, and power constraint.

In an embodiment, the indicator signal may be any one or a combination of: RRC messages, MAC control elements, or DCI messages.

In another aspect, the present disclosure relates to a base station, including a processor, and a memory operatively coupled to the processor, wherein the memory includes processor-executable instructions which, when executed by the processor, cause the processor to determine a condition of a channel between the base station and a UE, determine a configuration type from a plurality of DMRS configuration types based on the condition of the channel, wherein each DMRS configuration from the plurality of DMRS configuration types has a different number of resource elements allocated for transmitting a DMRS in an uplink signal or a downlink signal, and transmit an indicator signal to the UE to indicate a position of one or more resource elements of at least one resource block forming a resource block group allocated for the DMRS in the uplink signal or downlink signal.

In an embodiment, the memory may include processor-executable instructions which, when executed by the processor, cause the processor to allocate the one or more resource elements in a frequency domain based on the condition of the channel, wherein to allocate the one or more resource elements in the frequency domain, the processor may determine the position and a frequency of the one or more resource elements based on any one or a combination of: Channel Quality Indicator, RSRP, RSRQ, signal-to-noise ratio, number of antenna ports associated with the base station, HARQ feedback, cell throughput, and timing advance values transmitted to the UE of a preceding time interval of a predetermined duration.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example representation for Demodulation Reference Signal (DMRS)-based channel estimation.

FIG. 2 illustrates an example representation of Physical Downlink Shared Channel (PDSCH) DMRS location in frequency domain for mapping type A and type B.

FIG. 3 illustrates an example representation of PDSCH DMRS location in frequency domain for configuration type 1 and type 2.

FIG. 4 illustrates an example representation of PDSCH DMRS location based on DMRS antenna ports.

FIG. 5 illustrates an example representation of Physical Uplink Shared Channel (PUSCH) DMRS location for cyclic prefix Orthogonal Frequency-Division Multiplexing (CP-OFDM).

FIG. 6 illustrates an example system architecture for DMRS configuration selection, in accordance with an embodiment of the present disclosure.

FIG. 7 illustrates an example representation of DMRS configuration type 3, in accordance with an embodiment of the present disclosure.

FIG. 8A illustrates an example representation of DMRS configuration type 4 for Code Division Multiplexing (CDM) group 0 for PDSCH, in accordance with an embodiment of the present disclosure.

FIG. 8B illustrates an example representation of DMRS configuration type 4 for CDM group 1 for PDSCH, in accordance with an embodiment of the present disclosure.

FIG. 8C illustrates an example representation of DMRS configuration type 4 with Resource Block Group (RBG) of 4, in accordance with an embodiment of the present disclosure.

FIG. 9A illustrates an example representation of a learning model for selecting RBG size for frequency domain allocation of DMRS, in accordance with an embodiment of the present disclosure.

FIG. 9B illustrates an example representation of a learning model for determining a frequency of DRMS for time domain allocation of DMRS, in accordance with an embodiment of the present disclosure.

FIG. 10A illustrates an example representation for DMRS allocation for resource allocation type 0, in accordance with an embodiment of the present disclosure.

FIG. 10B illustrates an example representation for DMRS allocation for resource allocation type 1, in accordance with an embodiment of the present disclosure.

FIG. 11 illustrates an example representation of Medium Access Control (MAC) Control Element (CE) for dynamic DMRS configuration for both downlink and uplink, in accordance with an embodiment of the present disclosure.

FIG. 12 illustrates a sequence diagram for an example method for dynamic DMRS configuration, in accordance with an embodiment of the present disclosure.

FIG. 13A illustrates a flow chart of an example method for dynamic DMRS configuration for downlink PDSCH, in accordance with an embodiment of the present disclosure.

FIG. 13B illustrates a flow chart of an example method for dynamic DMRS configuration for uplink PUSCH, in accordance with an embodiment of the present disclosure.

FIG. 14 illustrates an exemplary computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

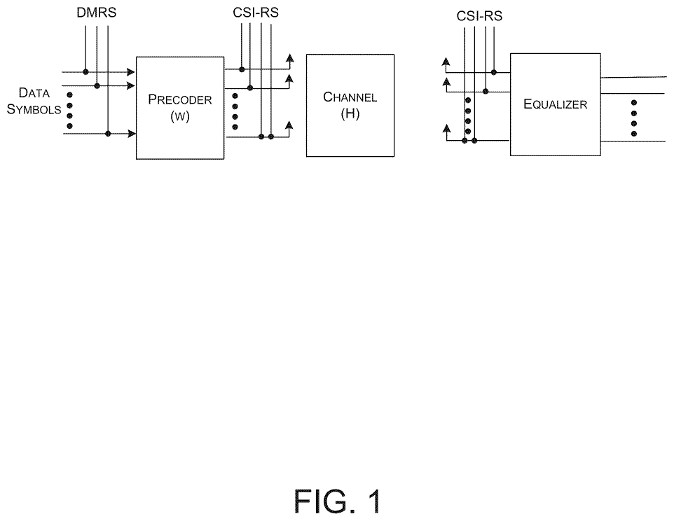

FIG. 1 illustrates an example representation for Demodulation Reference Signal (DMRS)-based channel estimation.

DMRS signals are used for channel estimations, among other applications, in communication networks. Channel estimations may be performed by causing a known payload/data symbols to be transmitted via a channel, such as a telecommunication network (4^{th} generation (4G), 5^{th} generation (5G), 6^{th} generation (6G), and the like), but not limited thereto. Since the data symbols are known, channel estimations can be derived by comparing the data symbols with those received in the DMRS through the channel, which may have been distorted due to characteristics of the channel (such as noise, interference, signal strength, physical characteristics of channel, and the like). Data symbols along with the associated DMRS may be passed to a precoder matrix W, which then propagates/is transmitted through the channel with the channel matrix H, thereby allowing the DMRS to have the combined effect of both the precoder and the channel. At the receiver side, the decoding of the data symbols may be performed by estimating the combined effect of the precoder and the channel matrix.

Assuming that the data symbol X is transmitted along with DMRS symbols X_{dmrs}. Both the data symbol and DMRS symbols go through the same precoding matrix, W and channel, H. This combined effect of W and H may be represented as H_{comb}=WH. The received DMRS signal at the receiver end may be represented as Equation 1.

$${Y}_{dmrs} = {WHX}_{dmrs} = {H}_{comb} {X}_{dmrs} \qquad Equation 1$$

As the DMRS symbol X_{dmrs} is known as the receiver, it can properly estimate the H_{comb}. So, when the actual PDSCH data X_{PDSCH} is transmitted, the receiver can efficiently decode the message with the knowledge of H_{comb}.

The configuration of the DMRS, which involves the mapping of DMRS onto time-frequency resources, exhibits variability contingent upon diverse usage and deployment scenarios. The allocation of time-frequency resources to the DMRS gives rise to distinct configurations in both the time and frequency domains, applicable to both physical downlink shared channel (PDSCH) and physical uplink shared channel (PUSCH).

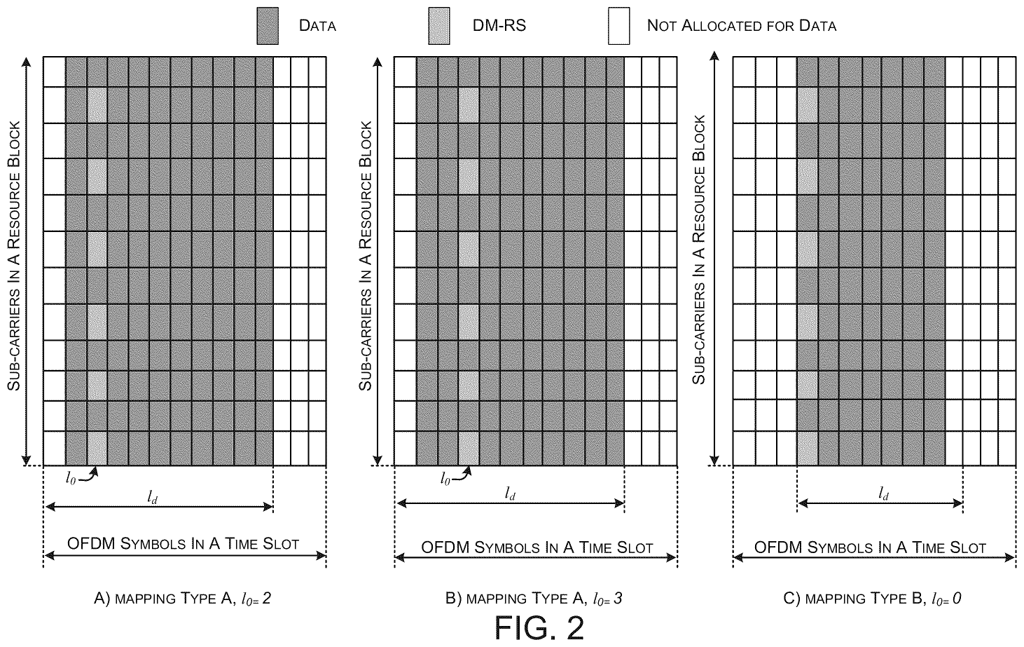

FIG. 2 illustrates an example representation of PDSCH DMRS location in frequency domain for mapping type A and type B.

In the case of PDSCH, the DMRS is supported for up to 12 orthogonal antenna ports for multi-input multi-output (MIMO) transmission. Also, in time domain, it can support a maximum of 4 DMRS in a single slot. The additional DMRS is used to estimate the channel efficiently in the case of highly varying channel or high mobility users, where the channel conditions vary rapidly. There are two different DMRS mapping types based on the PDSCH mapping type. The mapping type determines the allocation of DMRS in the time domain. In mapping type A, the DMRS location is defined with respect to the first orthogonal frequency division multiplexing (OFDM) symbol of the slot. The first DMRS location (represented by l₀) will be either 2^{nd} or 3^{rd} in the case of mapping type A, as shown in FIG. 2. This mapping type is used in cases where the data occupies the majority of the slot. For mapping type B, the DMRS location is defined with respect to the first OFDM symbol allocated to PDSCH resources and the first DMRS location is always 0, as shown in FIG. 2. There can be additional DMRS allocation in both mapping type A and mapping type B which is configured by the higher layer parameter “dmrs-AdditionalPosition”. Also, double symbol DMRS can also be configured to support larger number of antenna ports (i.e., support two distinct DMRS in adjacent symbols in time domain). The mapping type of the DMRS is signalled to user equipment (UE) through a radio resource control (RRC) setup message in the PDSCH. The number of additional DMRS can vary in the range of 0-3. Tables 7.4.1.1.2-3 and 7.4.1.1.2-4 in 3^{rd} Generation Partnership Project (3GPP) Technical Specification (TS) 38.211 specify the DMRS symbol allocation. Duration of the OFDM symbols (represented by l_{d}), i.e. duration between first OFDM symbol and last OFDM symbol allocated for PDSCH, may vary based on the additional DMRS. FIG. 2 shows the mapping type A having l_{d} of 11, and the mapping type B having l_{d} equal to 7.

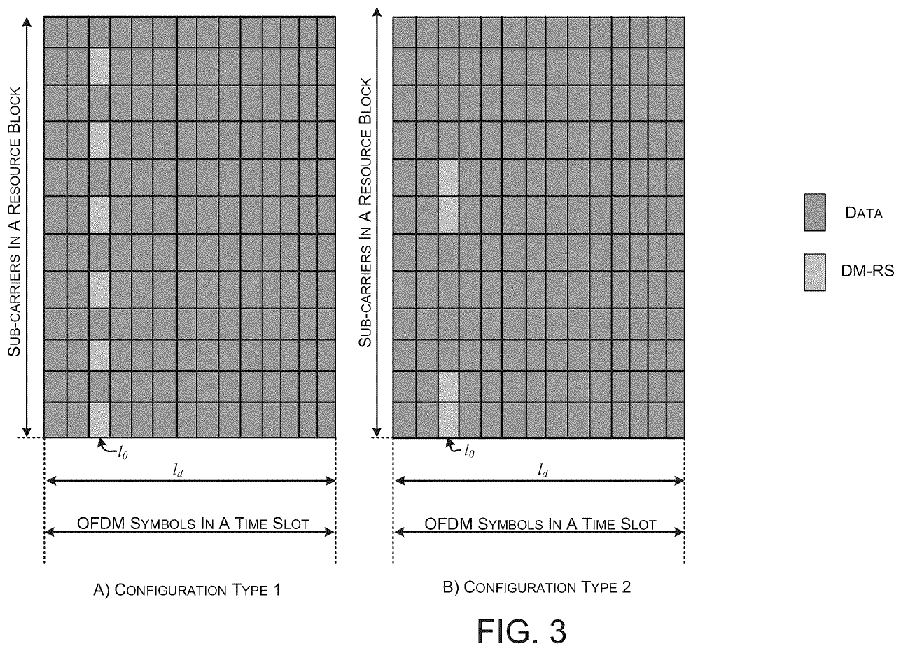

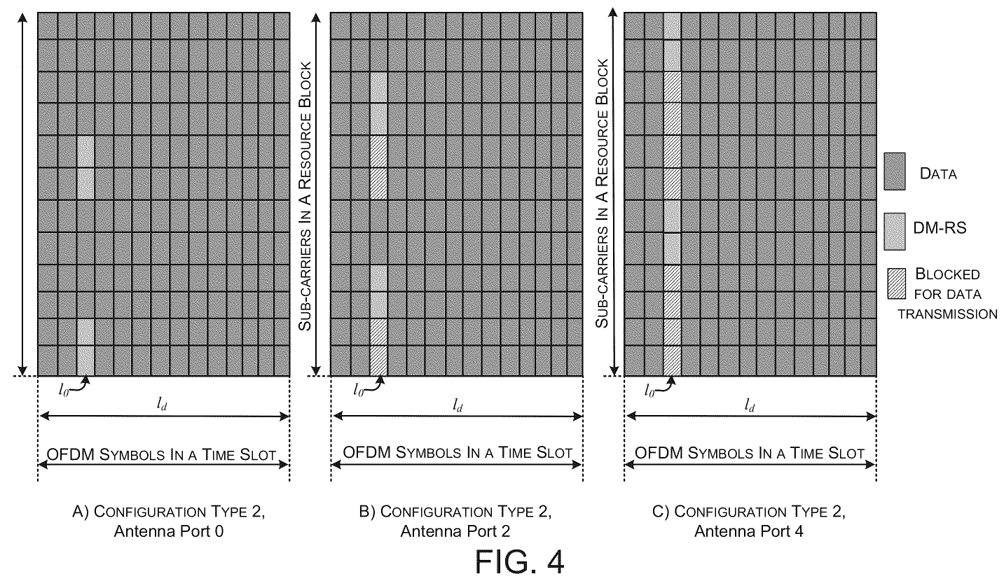

FIG. 3 illustrates an example representation of PDSCH DMRS location in frequency domain for configuration type 1 and type 2, and FIG. 4 illustrates an example representation of PDSCH DMRS location based on DMRS antenna ports.

There are two different DMRS configuration types based on the allocation in frequency domain: Configuration type 1 and Configuration type 2. In DMRS configuration type 1, the DMRS is allocated in alternate subcarriers across the physical resource block (PRB). So, the configuration type 1 contains six DMRS in a PRB for single symbol, as shown in FIG. 3. Also, it makes use of cyclic shifted pseudo random sequence which are orthogonal to each other to configure DMRS for multiple antenna ports, which distinguishes the DMRS in the code domain. Antenna ports 1000 and 1001 belong to the same code division multiplexing (CDM) group (CDM group 0) and are distinguished based on orthogonal codes (different cyclic shift of the pseudo-random sequence). Antenna ports 1002 and 1003 belong to the CDM group 1, which is distinguished from CDM group 0 in the frequency domain. Similarly, if more antenna ports need to be configured, two symbol DMRS needs to be allocated.

In the case of DMRS configuration type 2, the DMRS is allocated to two consecutive subcarriers in frequency domain. The DMRS is allocated in every third subcarrier pair in the frequency domain in an RB, as shown in FIG. 3. In this case, it can also support multiple CDM groups to support multiple antenna ports. By configuring the two symbol DMRS, it can support up to 12 different antenna ports.

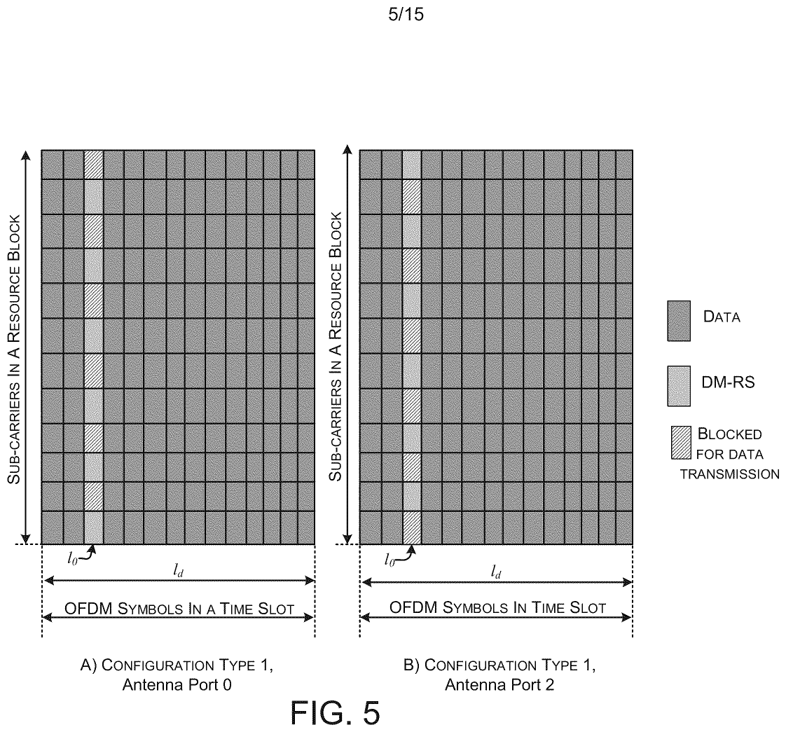

FIG. 5 illustrates an example representation of PUSCH DMRS location for cyclic prefix OFDM (CP-OFDM).

The DMRS configuration for the PUSCH depends on the type of waveform configured for PUSCH. If transform precoding is disabled, PUSCH is configured with CP-OFDM, whereas in the case where transform precoding is enabled, PUSCH is configured with Discrete Fourier Transform spread OFDM (DFT-s-OFDM). The PUSCH DMRS configuration is same as PDSCH DMRS except for the case when frequency hopping is enabled, or the transform precoding is enabled.

When the DFT-s-OFDM is used, it can support only a single layer transmission. It is mainly used for the case of low coverage. The DMRS is time-multiplexed with uplink (UL) transmissions and it will block all the resource elements (REs) for UL data transmission in OFDM symbols used for carrying DMRS. The time domain allocation for DMRS is the same for both DFT-s-OFDM and CP-OFDM, which are having same configuration as PDSCH DMRS. The frequency domain allocation in the case of DFT-s-OFDM always has DMRS configuration type as 1. Since it supports only a single layer transmission and only a single configuration type, the frequency domain allocation of DMRS is fixed in the case of DFT-s-OFDM.

In accordance with embodiments of the present disclosure, an adaptive DMRS configuration-based channel condition variation is described, where the allocation of DMRS in both time and frequency domain can be dynamically configured from the higher layer based on the channel conditions. The number of DMRS RE present in the frequency domain in an RB can be varied dynamically and the position of the DMRS within the RB can also be dynamically varied. Based on this dynamic configuration, two configuration types for DMRS for the frequency domain allocation of DMRS are described herein. The DMRS in the time domain can also be varied in a similar way, where DMRS REs can be punctured for specific slots based on the channel conditions. The punctured DMRS R's can be either used for the data transmission (PDSCH in the case of DL and/or PUSCH in the case of UL), or the punctured DMRS REs can be left vacant thereby improving the total channel power consumption. The decision whether to use the punctured DMRS for data transmission depends on the various factors like the traffic load demand, channel conditions, power constraints, etc. If the channel conditions remain constant over a certain part of bandwidth, certain RBs can also be grouped to resource block group (RBG) to transmit a common DMRS in a particular RB within that RBG. This decision is also taken at higher layers based on the channel conditions for both UL and DL independently. It also considers the scenarios where either UL or DL is scheduled like in the case of massive machine type communication (mMTC), where the data is predominantly sent in UL. The dynamic configuration of the DMRS can be signalled to the UE with the help of an indicator signal. This will help in reducing the RE utilization for the DMRS. For example, in the case of DMRS configuration type 3 and RBG size 10, the REs used for DMRS will be reduced from 1638 (for configuration type 1) to 28 in the case of 100 MHz bandwidth (273 PRBs), thereby reducing the RE utilization by almost 98% in the frequency domain.

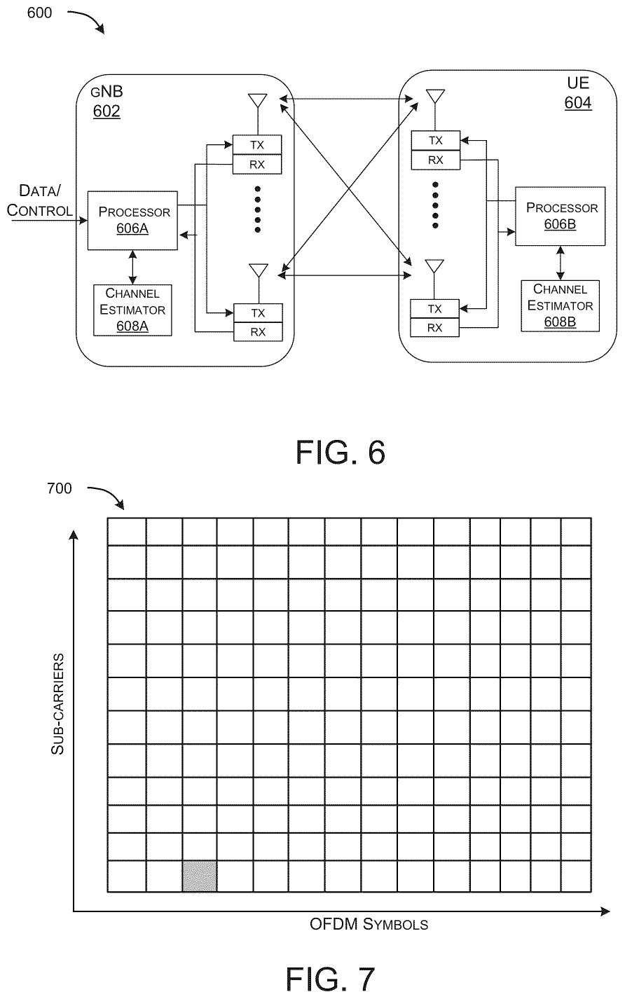

The various embodiments of the present disclosure will now be explained in detail with reference to FIGS. 6-14.

FIG. 6 illustrates an example system architecture 600 for DMRS configuration selection, in accordance with an embodiment of the present disclosure.

Referring to FIG. 6, the system architecture 600 includes a base station, i.e. a g Node B (gNB) 602 and a UE 604. The base station 602 includes a processor 606A and a channel estimator unit 608A. The UE 604 includes a processor 606B and a channel estimator unit 608B. The channel estimator unit 608A detects a condition of a channel. If the variation in the condition of the channel is low, i.e., below a predefined threshold for downlink (DL) or UL, the base station 602 may adaptively identify appropriate DMRS configuration for DL and UL independently based on a DL channel threshold and a UL channel threshold, respectively. The base station 602 may communicate the same to the UE 604.

In accordance with embodiments of the present disclosure, two new DMRS configuration types (i.e., type 3 and type 4) are described herein for DMRS allocation in frequency domain in the case of PDSCH and PUSCH (i.e., in the case of transform precoding disabled).

A radio protocol architecture of 5G consists of multiple layers which perform different functions. The different layers and its functionalities are specified in 3GPP TS 38.300. The physical (PHY) layer must support different dynamic DMRS configurations and bundling of RBs to RBG with a common DMRS. The Medium Access Control (MAC) layer must support the new MAC control element (CE) to inform the UE 604 about the dynamic DMRS configuration. Also, the MAC layer must decide the exact dynamic DMRS configuration based on the channel conditions. The RRC layer must support an information element (IE) to inform the UE 604 about the dynamic DMRS configuration in the case of both DL and UL. In accordance with embodiments of the present disclosure, the DMRS configuration type is chosen by higher layers (RRC/MAC) independently for UL and DL, based on the number of antenna ports supported and the channel conditions.

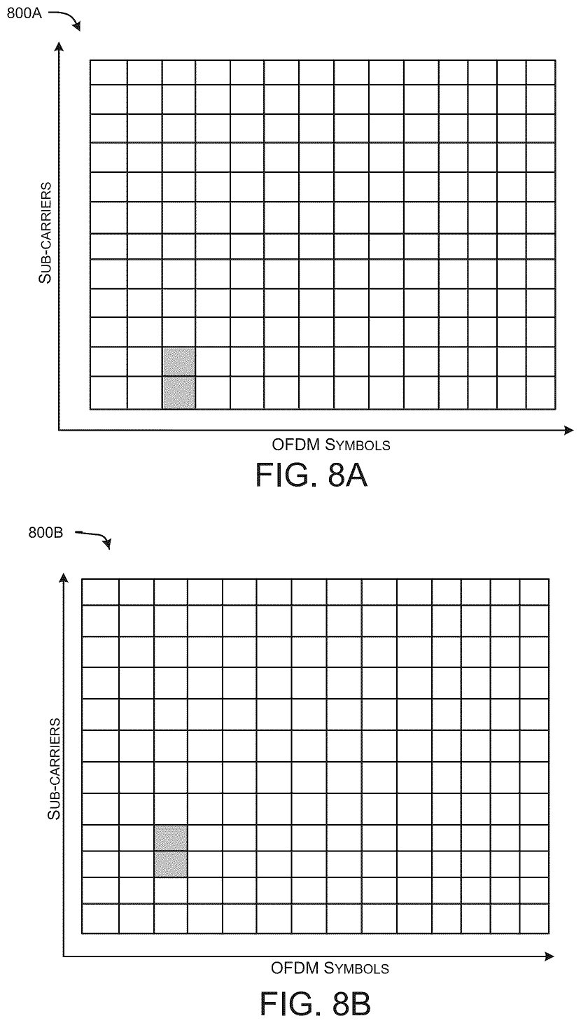

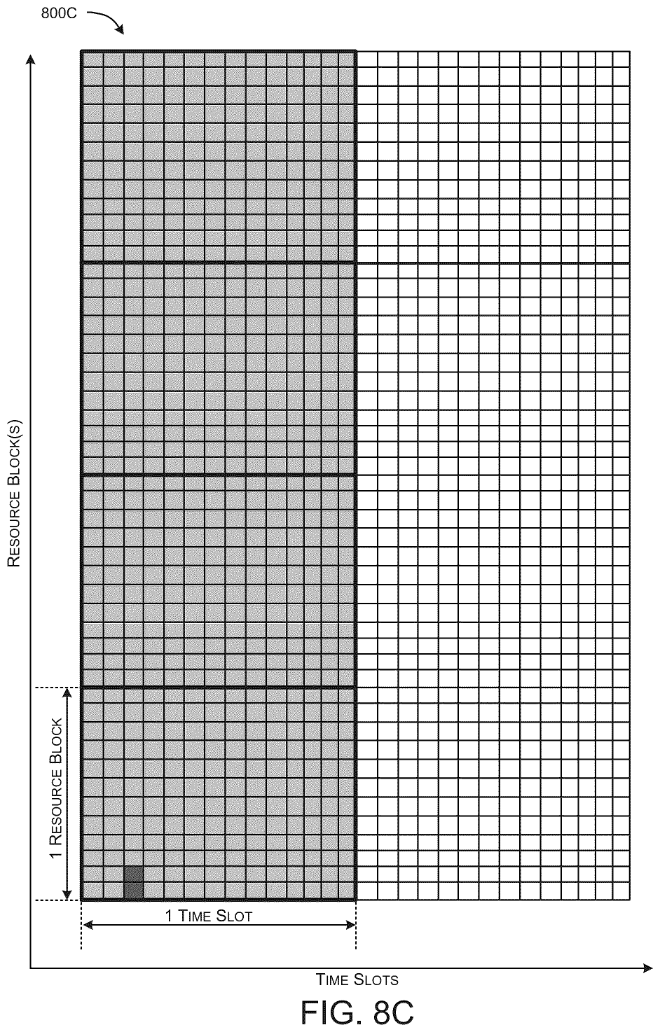

FIGS. 7 and 8A-8B illustrate example representations of a resource block with different configuration types. The resource block may have one or more resource elements represented on a grid of sub-carriers and OFDM symbols associated with the resource block.

FIG. 7 illustrates an example representation 700 of DMRS configuration type 3, in accordance with an embodiment of the present disclosure.

In DMRS configuration type 3, only a single DMRS symbol is present in the frequency domain in an RB. Configuration type 3 is chosen mainly when only a single antenna port is supported, and the channel conditions are constant over a configured bandwidth. If multiple antenna ports need to be configured, the DMRS can be frequency multiplexed for different antenna ports. Configuration type 3 may help to increase the data throughput by scheduling the data on the punctured DMRS positions.

FIG. 8A illustrates an example representation 800A of DMRS configuration type 4 for CDM group 0 (antenna port 1000 and 1001 for PDSCH), in accordance with an embodiment of the present disclosure. FIG. 8B illustrates an example representation 800B of DMRS configuration type 4 for CDM group 1 (antenna port 1002 and 1003 for PDSCH), in accordance with an embodiment of the present disclosure.

In DMRS configuration type 4, two DMRS are present in the frequency domain in an RB. Configuration type 4 is chosen when the channel conditions are constant over the configured bandwidth similar to the case in configuration type 3. If multiple ports are configured, the DMRS for different CDM groups are frequency multiplexed. Thus, it can support a maximum of 6 CDM groups (12 antenna ports) for single symbol DMRS. FIG. 8A and FIG. 8B show the DMRS configuration type 4 for different CDM groups (CDM group 0 and CDM group 1).

FIG. 8C illustrates an example representation 800C of DMRS configuration type 4 with RBG size 4, in accordance with an embodiment of the present disclosure.

In accordance with embodiments of the present disclosure, RBs are aggregated into RBG, and a lone DMRS is utilized for the RBG, which significantly reduces DMRS-induced RB occupancy. In an embodiment, the RBG size may be adjusted based on channel conditions. In the case of nomadic or slowly changing traffic conditions, where channel conditions remain relatively constant due to gradual fading, the coherence bandwidth is substantial. Thus, in such scenarios, aggregating multiple RBs and transmitting DMRS within a single RB proves feasible.

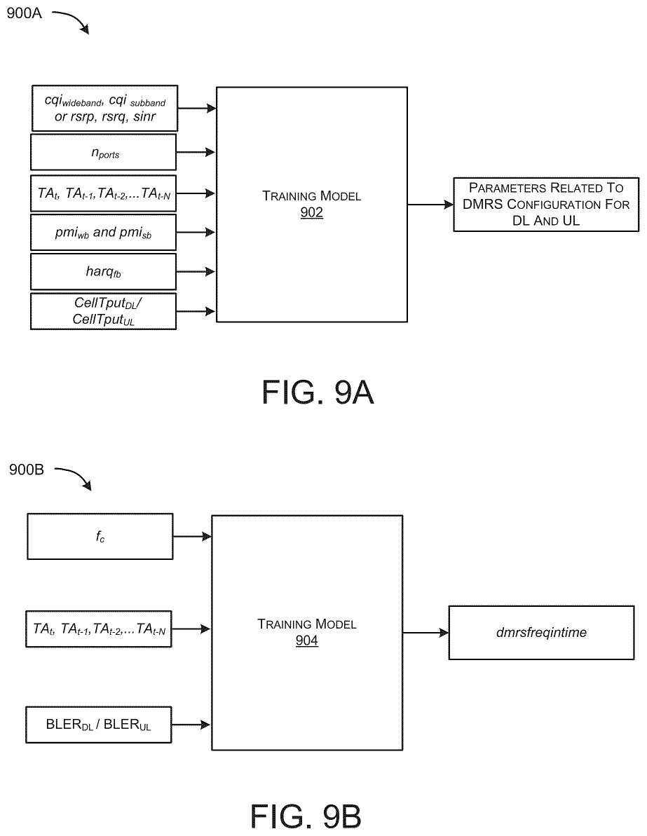

FIG. 9A illustrates an example representation 900A of a learning model for selecting RBG size for frequency domain allocation of DMRS, in accordance with an embodiment of the present disclosure.

In an embodiment, the selection of RBG may be done based on the use case and deployment scenarios for DL or UL independently. A training model 902 may consider multiple parameters to determine the RBG size, as shown in FIG. 9. As an example, FIG. 8C shows the case where 4 RBs are grouped together to form an RBG, and a common DMRS with configuration type 4 is allocated.

In an embodiment, the training model 902 may be a machine learning model, which may be trained with multiple parameters that may be used to determine the RBG size or in turn the coherence bandwidth. The parameters used to train the training model 902 include, channel quality indicator (CQI) values (cqi_{wideband} and cqi_{subband}) or Layer 3 cell measurements report including reports for both synchronization signal block (SSB) (rsrp_{ssb}) rsrq_{ssb}, sinr_{ssb}) and signal to interference noise ratio (SINR) based PUSCH packet data unit (PDU) in the case of UL (sinr_{pusch}), number of ports configured (nₚₒᵣₜₛ), Hybrid Automatic Repeat Request (HARQ) feedback (harq_{fb}) which can indicate the Block Error Rate (BLER), cell throughput for UL and DL (CellTput_{DL} and CellTput_{UL}), Precoding Matrix Indicator (PMI) for both the wideband and sub-band if present (pmi_{wb} and pmi_{sb}), and history of last N timing advance (TA) values.

The identified RBG size may be translated into multiple parameters which control the frequency domain allocation of the DMRS. These parameters may be used to configure the DMRS in the case of PDSCH and these parameters may be conveyed to the UE 604 for the DMRS configuration in the case of PUSCH.

FIG. 9B illustrates an example representation 900B of a learning model for determining a frequency of DRMS for time domain allocation of DMRS, in accordance with an embodiment of the present disclosure.

In an embodiment, the dynamic configuration of the DMRS in the time domain may be calculated based on the time coherence value i.e., the time duration over which the channel impulse response remains almost constant. The coherence time mainly depends on two parameters: center frequency (f_{c}) and maximum Doppler frequency (fₘ). The maximum Doppler frequency in turn depends on the relative mobility between a transmitter and a receiver, which can be determined by the history of TA values. The TA value is usually sent to the UE 604 by the base station 602 to adjust the UL transmission. It informs the UE 604 the amount of time it must advance the UL transmission as it provides the offset between the start of the received DL frame and the transmitted UL frame. If there is a relative mobility between the UE 604 and the base station 602, the TA value reported by the UE 604 may vary, whereas for a stationary UE, the TA values may be constant.

Referring to FIG. 9B, a training model 904 (e.g., a machine learning model) may be used to predict the time coherence by taking the center frequency and history of TA values as input. The output of the training model 904 may predict the dmrsfreqintime, which indicates the frequency of DMRS present in slots. For example, a dmrsfreqintime value equal to 2 signifies that only a single DMRS needs to be transmitted in 2 slots.

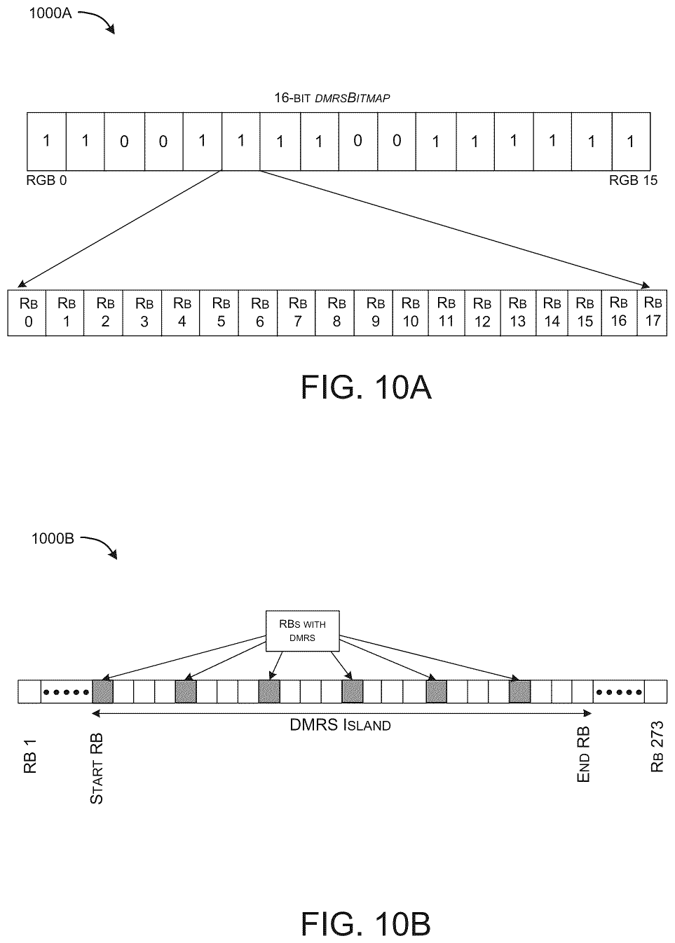

FIG. 10A illustrates an example representation 1000A for DMRS allocation for resource allocation type 0, in accordance with an embodiment of the present disclosure.

The dynamic DMRS configuration needs to be signalled to the UE 604 to inform the UE 604 about the DMRS location. In the case of PDSCH, the UE 604 requires the DMRS location to properly demodulate the PDSCH data. In the case of PUSCH, the UE 604 needs to be informed about the dynamic DMRS configuration to be applied on the PUSCH. In an embodiment, the UE 604 may be informed about a type of DMRS configuration and frequency of DMRS, i.e., dmrsfreqintime.

In an embodiment, the DMRS may have four different configuration types, as described herein. The configuration type which the UE 604 supports and also what the network configures needs to be informed in the case of both UL and DL. It can be indicated by the parameter dmrsConfigType. In an embodiment, the time domain allocation of the DMRS can be informed to the UE 604 using the downlink control indicator (DCI) with the help of a parameter, “Skip DMRS.” This parameter may indicate whether to puncture the DMRS with the PDSCH. If the bit is set to 1, it indicates that the DMRS can be punctured and the system (communication device) can use the punctured REs to schedule the PDSCH/PUSCH. The Skip DMRS parameter is a single bit parameter, which may be added to the DCI formats 0_0 or 0_1 for PUSCH and DCI formats 1_0 or 1_1 for PDSCH.

In an embodiment, based on the PDSCH or PUSCH resource allocation type (RA), type 0 (non-contiguous resource allocation) or type 1 (contiguous resource allocation), different parameters for the DMRS configuration in DL or UL may be possible. The DMRS may be scheduled within the PDSCH or PUSCH for DL or UL respectively.

Referring to FIG. 10A, for resource allocation type 0, the RB allocation is non-contiguous, and the frequency domain allocation is indicated with the help of a bitmap representing the RBG. A similar technique may be used for the DMRS frequency domain allocation in the case of resource allocation type 0. In an embodiment, an RBG may be generated by bundling 18 RBs to form a bitmap. The 16-bit bitmap may represent whether the DMRS is present within the given RBG. A parameter, dmrsBitmap specifies the DMRS bitmap for the DMRS allocation for the RBG. If the bit is set to 1, it indicates that the corresponding RBG has RB (or RBs) carrying the DMRS. A parameter, dmrsAllocinRbg specifies the pattern of the DMRS allocation within the RBG i.e., which RBs within the RBG carries the DMRS starting from the first RB within the RBG. For example, if the value of dmrsAllocinRbg is 3, it indicates there are 3 DMRS present within the RBG and it may be present in RBs 0, 8 and 17 i.e., the DMRS may be placed uniformly within the RBG. A 5-bit dmrsAllocinRbg may be used to represent the RBs carrying the DMRS within the RBG.

FIG. 10B illustrates an example representation 1000B for DMRS allocation for resource allocation type 1, in accordance with an embodiment of the present disclosure.

Referring to FIG. 10B, for resource allocation type 1, the memory allocation is contiguous, where the resource allocation in frequency domain is indicated by the start RB and the number of RBs. For the DMRS allocation, a resource allocation may be created by specifying the start RB and the end RB. This DMRS region (DR) may also be referred to as the “DMRS island” (DI), which specifies the region within which the DMRS is contained. The DMRS island may be the subset of the PDSCH or the PUSCH allocation. The specific location of RBs carrying the DMRS within the DR may be specified by the DMRS frequency (f_{dmrs}). A parameter, dmrsStartRb may specify the start RB of the DI, where the first DMRS is present in the RB specified by this parameter. It varies in the range of 1-275.

Further, a parameter, dmrsEndRb may specify the end RB of the DI, where the last DMRS is present in the RB specified by this parameter. It varies in the range of 1-275.

Another parameter, dmrsFreqinIsland may specify the frequency of the DMRS in the DI. It varies in the range of 1-138, where the value 138 specifies only a single DMRS within the DI if all 273 RBs are allocated.

In an embodiment, the location of the DMRS within the RB, i.e., the REs containing the DMRS signal for the configuration type 3 and type 4 may be determined based on the number of DMRS ports configured similar to configuration type 1 and type 2. The DMRS frequency allocation for resource allocation type 1 with the dmrsFreqinIsland value as 4, is shown as an example embodiment in FIG. 10B, which specifies that every fourth RB within the DMRS island carries the DMRS.

The parameters may be informed to the UE 604 in multiple ways, i.e. RRC reconfiguration message, RRC setup message, or MAC CE. In an embodiment, the parameters may be informed to the UE 604 using the RRC reconfiguration message or the RRC setup message. In another embodiment, the parameters may be informed to the UE 604 with the help of the MAC CE. In an embodiment, the range of values of the parameters may be given as follows:

$$dmrsConfigType \text{=>} \{ type 1 , type 2 , type 3 , type 4 \}$$

$$dmrsBitmap \text{=>} 16 - bit parameter$$

$$dmrsAllocinRbg \text{=>} 5 - bit parameter to indicate the DMRS location within RBG$$

$$dmrsStartRb \text{=>} 1 - 275$$

$$dmrsEndRb \text{=>} 1 - 275$$

$$dmrsFreqinIsland \text{=>} 1 - 138$$

If the DMRS configuration needs to be changed only for a few RBs, it can be done by specifying the dmrsStartRb, dmrsEndRb, and dmrsFreqinIsland for the RBs where the DMRS configuration needs to be updated.

The RRC IE to be used is given below for the dynamic DMRS configuration in both UL and DL. The DMRS-dynamic-config container can be added to the existing DMRS-DownlinkConfig and existing DMRS-UplinkConfig as per the 3GPP TS 38.331.

| | |
|---|---|
| DMRS-DownlinkConfig ::= | SEQUENCE { |

| | |
|---|---|
| dmrs-Type | ENUMERATED {type1, type2, type3, type4} |

OPTIONAL, -- Need R

| | |
|---|---|
| dmrs-AdditionalPosition | ENUMERATED {pos0, pos1, pos3} |

OPTIONAL, -- Need R

| | | |
|---|---|---|
| dmrs-group1 | BIT STRING (SIZE (12)) | OPTIONAL, -- |

Need R

| | | |
|---|---|---|
| dmrs-group2 | BIT STRING (SIZE (12)) | OPTIONAL, -- |

Need R

| | | |
|---|---|---|
| maxLength | ENUMERATED {len2} | OPTIONAL, -- |

Need R

| | | |
|---|---|---|
| scramblingID0 | INTEGER (0..65535) | OPTIONAL, -- |

Need S

| | | |
|---|---|---|
| scramblingID1 | INTEGER (0..65535) | OPTIONAL, -- |

Need S

| | |
|---|---|
| phaseTrackingRS | SetupRelease { PTRS-DownlinkConfig } |

OPTIONAL, -- Need M

| | | |
|---|---|---|
| dmrs-dynamic-config-dl | DMRS-dynamic-config-DL | OPTIONAL |

```
      ...
}
        DMRS-UplinkConfig ::= SEQUENCE {
```

| | |
|---|---|
| dmrs-Type | ENUMERATED {type1, type2, type3, type4} |

OPTIONAL, -- Need S

| | |
|---|---|
| dmrs-AdditionalPosition | ENUMERATED {pos0, pos1, pos3} |

OPTIONAL, -- Need S

| | |
|---|---|
| phaseTrackingRS | SetupRelease { PTRS-UplinkConfig } |

OPTIONAL, -- Need M

| | | |
|---|---|---|
| maxLength | ENUMERATED {len2} | OPTIONAL, -- Need S |

transformPrecodingDisabled SEQUENCE {

| | |
|---|---|
| scramblingID0 | INTEGER (0..65535) OPTIONAL, -- Need S |
| scramblingID1 | INTEGER (0..65535) |

```
  OPTIONAL, -- Need S
        ...,
        [[
```

| | |
|---|---|
| dmrs-Uplink-r16 | ENUMERATED {enabled} |

```
  OPTIONAL -- Need R
        ]]
    } OPTIONAL, -- Need R
```

| | |
|---|---|
| transformPrecodingEnabled | SEQUENCE { |
| nPUSCH-Identity | INTEGER(0..1007) |

OPTIONAL, -- Need S

| | |
|---|---|
| sequenceGroupHopping | ENUMERATED {disabled} |

OPTIONAL, -- Need S

| | |
|---|---|
| sequenceHopping | ENUMERATED {enabled} |

```
  OPTIONAL, -- Need S
        ...,
        [[
```

| | |
|---|---|
| dmrs-UplinkTransformPrecoding-r16 | SetupRelease {DMRS- |

```
UplinkTransformPrecoding-r16}
OPTIONAL -- Need M
        ]]
        } OPTIONAL, -- Need R
```

| | | |
|---|---|---|
| dmrs-dynamic-config-ul | DMRS-dynamic-config-UL | OPTIONAL |

...
}

The DMRS-dynamic-config-DL container for PDSCH DMRS configuration parameters are specified below in detail:

| DMRS-dynamic-config-DL ::= | SEQUENCE { | |
|---|---|---|
| dmrsBitmap | BIT STRING (SIZE (16)) | OPTIONAL, |
| dmrsAllocinRbg | BIT STRING (SIZE (5)) | OPTIONAL |
| dmrsStartRb | INTEGER (1..275) | OPTIONAL, |
| dmrsEndRb | INTEGER (1..275) | OPTIONAL, |

| | |
|---|---|
| dmrsFreqinIsland | INTEGER (0..138) |

OPTIONAL
}

The DMRS-dynamic-config-UL container for PUSCH DMRS configuration parameters are specified below:

| DMRS-dynamic-config-UL ::= | SEQUENCE { | |
|---|---|---|
| dmrsBitmap | BIT STRING (SIZE (16)) | OPTIONAL, |
| dmrsAllocinRbg | BIT STRING (SIZE (5)) | OPTIONAL |
| dmrsStartRb | INTEGER (1..275) | OPTIONAL, |
| dmrsEndRb | INTEGER (1..275) | OPTIONAL, |

| | |
|---|---|
| dmrsFreqinIsland | INTEGER (0..138) |

OPTIONAL
}

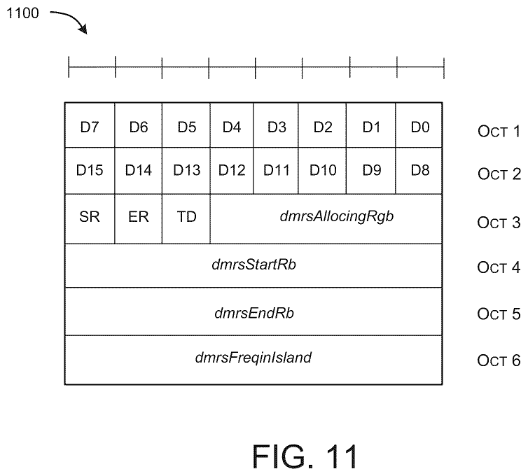

FIG. 11 illustrates an example representation 1100 of MAC CE for dynamic DMRS configuration for both DL and UL, in accordance with an embodiment of the present disclosure.

Referring to FIG. 11, the new MAC CE for dynamic DMRS configuration for both DL and UL is shown. Dᵢ represents the 16-bit dmrsBitmap. If the bit is set to 1, it indicates that the corresponding RBG has RB (or RBs) carrying the DMRS. dmrsAllocinRbg is a 5-bit parameter to indicate the DMRS location within RBG. TD bit is used to specify whether the dynamic DMRS configuration is for the case of DL or UL. If the bit is set to 0, it specifies the MAC CE is for PDSCH DMRS configuration. If bit is set to 1, it specifies the MAC CE is for PUSCH DMRS configuration. SR specifies the 1^{st} bit of the DMRS start RB position. ER specifies the 1^{st} bit of the DMRS end RB position. dmrsStartRb specifies the remaining bits for the start RB position of DMRS. dmrsStartRb (2^{nd}-9^{th} bit) is combined with SR (1^{st} bit) to get the complete information about the starting RB position of DMRS. dmrsEndRb specifies the remaining bits for the end RB position of DMRS. dmrsEndRb (2^{nd}-9^{th} bit) is combined with ER (1^{st} bit) to get the complete information about the end RB position of DMRS. dmrsFreqinIsland is an 8-bit parameter that indicates the frequency of the DMRS in the DI.

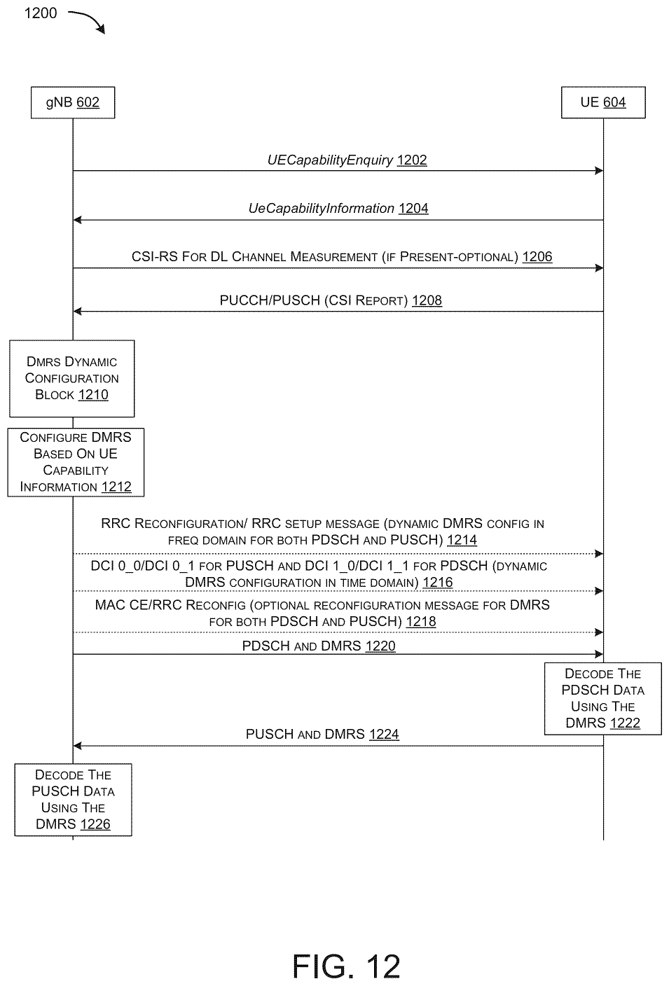

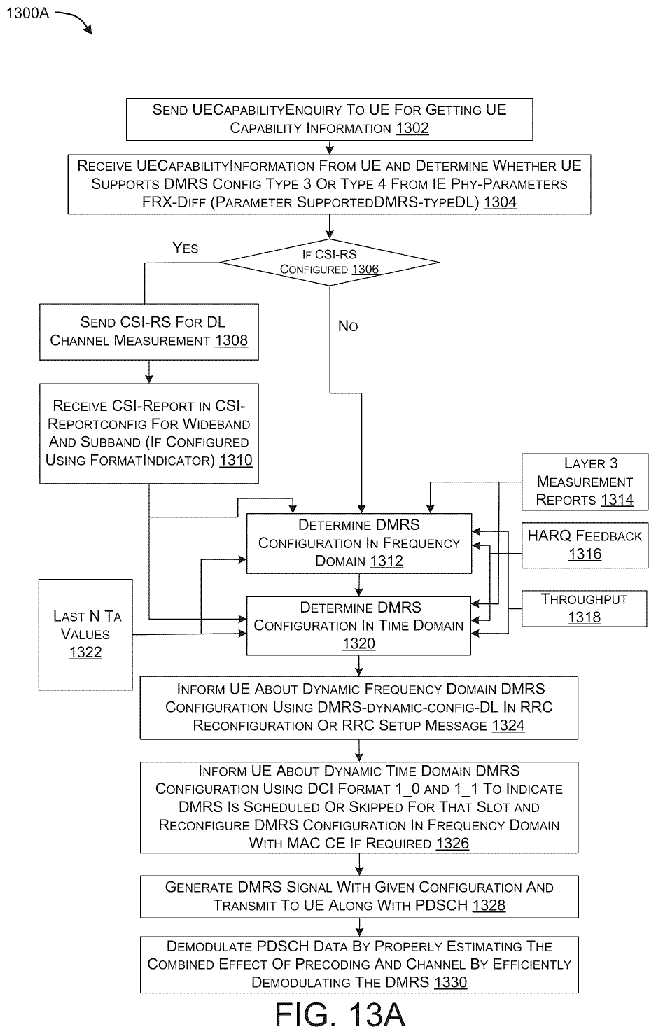

FIG. 12 illustrates a sequence diagram for an example method 1200 for dynamic DMRS configuration, in accordance with an embodiment of the present disclosure.

Referring to FIG. 12, at step 1202, a UE enquiry signal, i.e. UECapabilityEnquiry is transmitted by the base station 602. At step 1204, a UE capability information signal, i.e. UECapabilityInformation is received by the base station 602 from the UE 604. In an embodiment, the UE capability information signal comprises data on capabilities of the UE 604, for example, supported DMRS configuration. This information may also be carried in the IE phy-ParametersFRX-Diff and may be specified by the parameters “supportedDMRS-TypeDL type3” and “supportedDMRS-TypeDL type4” for DL and “supportedDMRS-TypeUL type3” and “supportedDMRS-TypeUL type4” for UL.

At step 1206, optionally, a Channel State Information-Reference Signal (CSI-RS) is transmitted by the base station 602 to the UE 604 for DL channel measurement if it is configured. At step 1208, the UE 604 sends channel measurements reports to the base station 602 in a CSI report in Physical Uplink Control Channel (PUCCH) or PUSCH in the CSI-ReportConfig. The base station 602 receives the channel reports for the wideband and sub-band (if configured using pmi-FormatIndicator=subband PMI and cqi-FormatIndicator=subband CQI) which includes CQI, PMI, and rank indicator (RI).

In an embodiment, the base station 602 determines a condition of a channel between the base station 602 and the UE 604. The condition of the channel is determined based on, but not limited to, the CSI report. At step 1210, the base station 602 determines a configuration type from a plurality of DMRS configuration types based on the condition of the channel. As discussed herein, each DMRS configuration type has a different number of resource elements allocated for transmitting a DMRS in an UL signal or a DL signal. For example, the base station 602 may utilize the channel measurement reports (wideband and sub-band CQI, wideband and sub-band PMI) for determining DMRS allocation in the frequency domain. This process considers the UECapabilityInformation to verify UE support for DMRS configuration types 3 and 4 in the parameter “supportedDMRS-TypeDL type3” and “supportedDMRS-TypeDL type4” for DL and “supportedDMRS-TypeUL type3” and “supportedDMRS-TypeUL type4” for UL.

In an embodiment, the base station 602 may employ a model, for example, a training model 902 of FIG. 9A, to determine the DMRS allocation parameters in frequency domain. The training model 902 may use the channel measurement reports to determine the coherence bandwidth, which in turn will determine the RBG size for sending the DMRS.

$$RBG size = f ( {cqi}_{wideband} , {cqi}_{subband} , {rsrp}_{ssb} , {rsrq}_{ssb} , \\ sin {r}_{ssb} , sin {r}_{pusch} , {n}_{ports} , {harq}_{fb} , {CellTput}_{DL} / {CellTput}_{UL} , \\ {pmi}_{wb} , {pmi}_{sb} , [ {TA}_{t} , {TA}_{t - 1} , {TA}_{t - 2} , ... .. , {TA}_{t - N} ] , ) \qquad Equation 2$$

Similarly, the base station 602 may use a model, for example, a training model 904 of FIG. 9B, to determine the DMRS allocation parameters. The training model 904 may dynamically calculate the coherence time from the last N samples of TA, center frequency and the BLER reported in UL/DL.

$$dmrsfreqintime = f ( [ {TA}_{t} , {TA}_{t - 1} , {TA}_{t - 2} , ... .. , {TA}_{t - N} ] , {f}_{c} , {BLER}_{UL / DL} , )$$

The RBG size may be used to calculate the DMRS frequency domain allocation parameters like dmrsBitmap, dmrsAllocinRbg, dmrsStartRb, dmrsEndRb, and dmrsFreqinIsland. For the dynamic time domain allocation of DMRS, the base station 602 may decide whether to skip DMRS for certain slots based on the dmrsfreqintime value. The only condition being there should be at least one DMRS allocated in a slot every dmrsfreqintime number of slots.

At step 1212, the base station 602 allocates one or more REs for DMRS based on the capabilities of the UE 604. In some embodiments, the one or more REs are allocated based on the condition of the channel. For example, the base station 602 generates the DMRS with the calculated DMRS allocation parameters along with PDSCH data. At steps 1214, 1216, and 1218, an indicator signal is transmitted by the base station 602 to the UE 604 to indicate a position of the one or more REs of at least one RB forming an RBG allocated for the DMRS in the UL signal or DL signal. In an embodiment, at step 1214, the indicator signal may be an RRC configuration or setup message (DMRS-dynamic-config-DL or DMRS-dynamic-config-UL) for DMRS configuration in frequency domain for both PDSCH and PUSCH. In an embodiment, the base station 602 may allocate the REs in the frequency domain based on the condition of the channel, where the base station 602 determines the position and a frequency of the REs based on, but not limited to, Channel Quality Indicator, Reference Signal Received Power (RSRP), Reference Signal Received Quality (RSRQ), signal-to-noise ratio, number of antenna ports associated with the base station 602, HARQ feedback, cell throughput, and TA values transmitted to the UE 604 of a preceding time interval of a predetermined duration.

In an embodiment, the base station 602 allocates the REs for the DMRS in at least one RB forming RBG, where a number of RBs in the RBG may be determined based on the condition of the channel. In an embodiment, for non-contiguous PUSCH allocations or PDSCH allocation of the REs for the DMRS, the base station 602 may transmit a bitmap having one or more bits corresponding to the RBG through the indicator signal, a value of each of the one or more bits in the bitmap indicating a presence of the DMRS in the RBG, and a position parameter that indicates the position of the DMRS within each RB in the RBG having the DMRS. In another embodiment, for contiguous PUSCH allocation or PDSCH allocation, the base station 602 may transmit a start RB in the RBG, an end RB in the RBG, and an RB frequency to indicate a location of the REs having the DMRS.

In an embodiment, the base station 602 may allocate, based on an UL threshold and a DL threshold, one of: one RE for the DMRS in the DL signal and the UL signal when the condition of the channel is constant over the configured bandwidth, two REs in the DL signal and the UL signal based on a change in the condition of the channel over the configured bandwidth, one RE for the DMRS in the DL signal, and two REs for the DMRS for the UL signal, or two REs for the DMRS in the DL signal and one RE for the DMRS in the UL signal.

In an embodiment, the base station 602 determines a number of time slots to be associated with each DMRS in the UL signal or DL signal based on, but not limited to, the condition of the channel, and a time coherence value based on a center frequency, TA values in a predetermined preceding interval, and a BLER. At step 1216, the base station 602 transmits DCI to indicate number of time slots to be associated with each DMRS in the UL signal or DL signal.

In an embodiment, at step 1218, the indicator signal may be a MAC CE or RRC reconfiguration/setup message, i.e. optional reconfiguration message for DMRS for both PDSCH and PUSCH. It may be appreciated that the indicator signal may include, but not limited to, the position of the one or more REs allocated for the DMRS in the DL signal or the UL signal, a number of the one or more REs allocated for the DMRS, a start position of the RB, an end position of the RB, and a frequency of the one or more REs.

At step 1220, the downlink signal with the DMRS configured at the allocated positions of the one or more REs may be transmitted from the base station 602. In an embodiment, the base station 602 may allocate a first set of REs in the DL signal for the DRMS, in which case, the indicator signal may indicate positions of the first set of REs having the DMRS in the DL signal. In another embodiment, the base station 602 may allocate a second set of REs in the UL signal for the DMRS, in which case, the indicator signal may indicate positions of the second set of REs for the DMRS in the uplink signal from the UE 604.

In an embodiment, the base station 602 may transmit the DL signal to the UE 604 with the DMRS in one or more time slots equal to the determined number of time slots. The base station 602 may allocate the DMRS in a first time slot. The base station 602 may skip allocation of the DMRS for subsequent time slots.

Referring to FIG. 12, at step 1222, the UE 604 may decode the PDSCH received from the base station 602 at step 1220 using the DMRS. At step 1224, the UE 604 transmits the UL signal on the PUSCH having the DMRS. At step 1226, the base station 602 may decode the PUSCH using the DMRS.

In an embodiment, the base station 602 may transmit data or null signal through a subset of REs from the one or more REs based on, but not limited to, traffic load demand, channel conditions, and power constraints. In an embodiment, the UE 604 may transmit data or null signal through a subset of time slots among the total number of time slots based on, but not limited to, the traffic load demand, the channel conditions, and the power constraints.

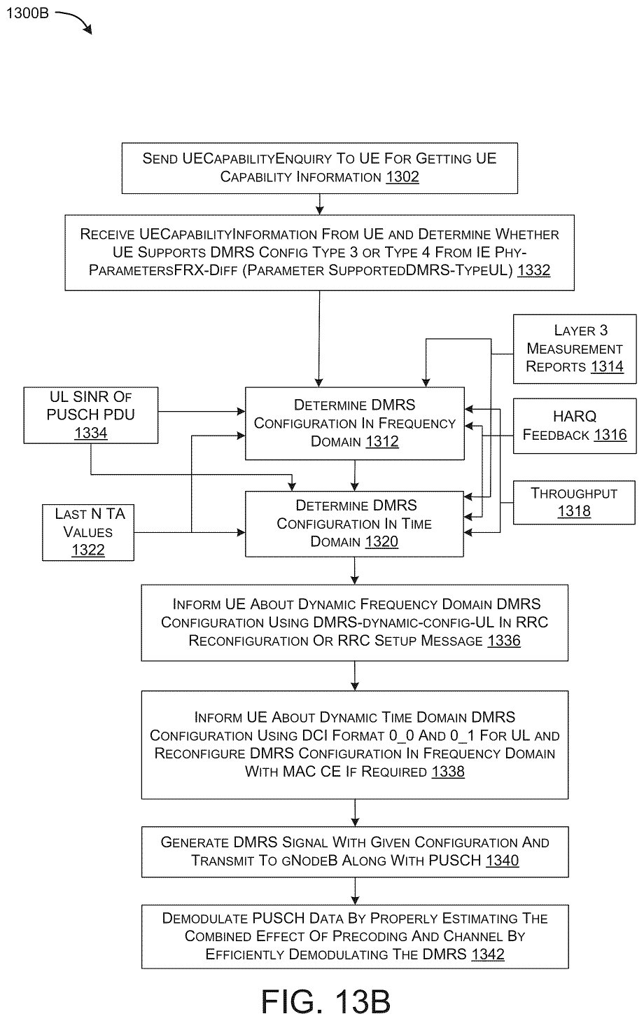

FIG. 13A illustrates a flow chart of an example method 1300A for dynamic DMRS configuration for DL PDSCH, in accordance with an embodiment of the present disclosure. It may be appreciated that the steps of the method 1300A may be performed by the base station 602, or the processor 606A and/or the channel estimator unit 608A in the base station 602.

Referring to FIG. 13A, at step 1302, the method 1300A includes sending a UE capability enquiry signal to a UE 604 for getting UE capability information signal. At step 1304, the method 1300A includes receiving the UE capability information signal from the UE 604. Further, the method 1300A includes determining whether the UE 604 supports DMRS configuration type 3 or type 4 from IE phy-ParametersFRX-Diff (i.e., parameter supportedDMRS-TypeDL).

At step 1306, the method 1300A includes determining if CSI-RS is configured. In response to the CSI-RS being configured, the method 1300A, at step 1308, includes sending the CSI-RS for DL channel measurement. At step 1310, the method 1300A includes receiving CSI report in CSI-ReportConfig for wideband and sub-band (if configured using FormatIndicator). In another embodiment, if the CSI-RS is not configured, the method 1300A, at step 1312, includes determining DMRS configuration in frequency domain based on, but not limited to, the CSI report, PMI, CQI, RI, layer 3 measurement reports 1314, HARQ feedback 1316, throughput 1318, last ‘n’ TA values 1322, or the like.

At step 1320, the method 1300A includes determining DMRS configuration in time domain based on, but not limited to, the CSI report, last ‘n’ TA values 1322, layer 3 measurement reports 1314, HARD feedback 1316, throughput 1318, or the like.

At step 1324, the method 1300A includes informing the UE 604 about dynamic frequency domain DMRS configuration using dmrs-dynamic-config-DL in RRC reconfiguration or RRC setup message. Further, at step 1326, the method 1300A includes informing the UE 604 about dynamic time domain DMRS configuration using DCI format 1_0 and 1_1 to indicate whether DMRS is scheduled or skipped for that slot, and reconfigure DMRS configuration in frequency domain with MAC CE, if required.

At step 1328, the method 1300A includes generating DMRS signal with the given configuration and transmitting to the UE 604 along with PDSCH. At step 1330, the method 1300A includes demodulating PDSCH data by estimating the combined effect of precoding and channel by efficiently demodulating the DMRS. The step 1330 may be performed at the UE 604.

FIG. 13B illustrates a flow chart of an example method 1300B for dynamic DMRS configuration for UL PUSCH, in accordance with an embodiment of the present disclosure. It may be appreciated that the steps of the method 1300B may be performed by the base station 602, or the processor 606A and/or the channel estimator unit 608A in the base station 602. It may be appreciated that similar reference numerals in method 1300B depict similar steps of method 1300A, and hence, may not be described again for the sake of brevity.

Referring to FIG. 13B, at step 1332, the method 1300B includes receiving UE capability information signal from the UE 604 to determine whether UE 604 supports DMRS configuration type 3 or type 4 from IE phy-parametersFRX-diff (parameter supporteddmrs-typeUL).

At step 1334, UL SINR of PUSCH PDU may also be considered for determining DMRS configuration in frequency domain and time domain. At step 1336, the method 1300B includes informing the UE 604 about dynamic frequency domain DMRS configuration using dmrs-dynamic-config-UL in RRC reconfiguration or RRC setup message. Further, at step 1338, the method 1300B includes informing the UE 604 about dynamic time domain DMRS configuration using DCI format 0_0 and 0_1 for UL, and reconfigure DMRS configuration in frequency domain with MAC CE, if required.

At step 1340, the method 1300B includes generating DMRS signal with the given configuration and transmitting to the base station 602, such as a gNodeB, along with PUSCH. At step 1342, the method 1300B includes demodulating PUSCH data by estimating the combined effect of precoding and channel by efficiently demodulating the DMRS.

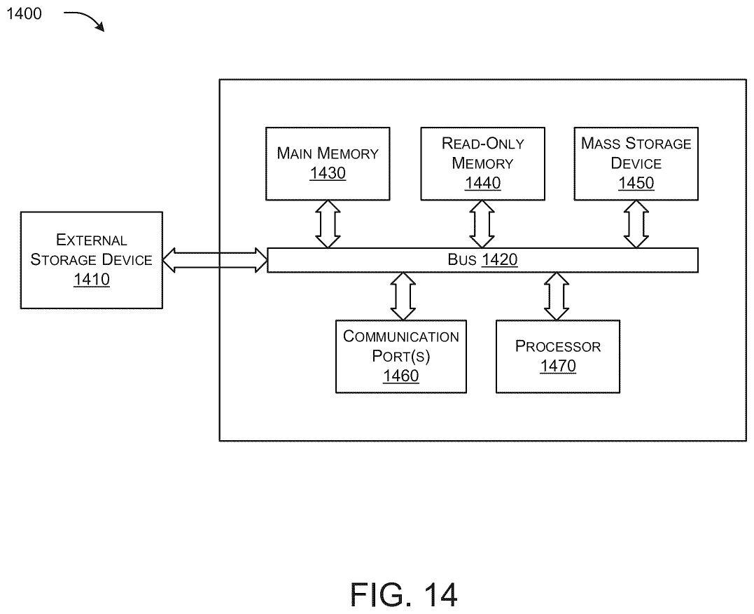

FIG. 14 illustrates an exemplary computer system 1400 in which or with which embodiments of the present disclosure may be implemented.

The blocks of the flow diagrams shown in FIGS. 13A and 13B have been arranged in a generally sequential manner for ease of explanation; however, it is to be understood that this arrangement is merely exemplary, and it should be recognized that the processing associated with methods (1300A, 1300B) may occur in a different order (for example, where at least some of the processing associated with the blocks is performed in parallel and/or in an event-driven manner). Further, it may be appreciated that the steps shown in FIGS. 13A and 13B are merely illustrative. Other suitable steps may be used for the same, if desired. Moreover, the steps of the method (1300A, 1300B) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 14, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 14 illustrates an exemplary computer system 1400 in which or with which embodiments of the present disclosure may be utilized. The computer system 1400 may be implemented as or within the base station described in accordance with embodiments of the present disclosure.

As depicted in FIG. 14, the computer system 1400 may include an external storage device 1410, a bus 1420, a main memory 1430, a read-only memory 1440, a mass storage device 1450, communication port(s) 1460, and a processor 1470. A person skilled in the art will appreciate that the computer system 1400 may include more than one processor 1470 and communication ports 1460. The processor 1470 may include various modules associated with embodiments of the present disclosure. The communication port(s) 1460 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 1460 may be chosen depending on a network, such a Local Area Network (LAN), Wide Area Network (WAN), or any network to which the computer system 1400 connects.

In an embodiment, the main memory 1430 may be Random Access Memory (RAM), or any other dynamic storage device commonly known in the art. The read-only memory 1440 may be any static storage device(s) e.g., but not limited to, a Programmable Read Only Memory (PROM) chips for storing static information e.g., start-up or basic input output system (BIOS) instructions for the processor 1470. The mass storage device 1450 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus 1420 communicatively couples the processor 1470 with the other memory, storage, and communication blocks. The bus 1420 may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor 1470 to the computer system 1400.

In another embodiment, operator and administrative interfaces, e.g., a display, keyboard, and a cursor control device, may also be coupled to the bus 1420 to support direct operator interaction with the computer system 1400. Other operator and administrative interfaces may be provided through network connections connected through the communication port(s) 1460. Components described above are meant only to exemplify various possibilities. In no way should the aforementioned exemplary computer system 1400 limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure facilitates efficient and adaptive Demodulation Reference Signal (DMRS) configuration.

The present disclosure facilitates in increasing data throughput in both uplink and downlink.

The present disclosure facilitates in reducing channel power by the DMRS, and thereby reduce the total power consumption.

The present disclosure facilitates in reduce Resource Element utilization for DMRS.

I/We claim:

1. A method for dynamic Demodulation Reference Signal (DMRS) configuration, comprising:
determining, by a base station (602), a condition of a channel between the base station (602) and a User Equipment (UE) (604);
determining, by the base station (602), a configuration type from a plurality of DMRS configuration types based on the condition of the channel, wherein each DMRS configuration from the plurality of DMRS configuration types has a different number of resource elements allocated for transmitting a DMRS in an uplink signal or a downlink signal; and
transmitting, by the base station (602), an indicator signal to the UE (604) to indicate a position of one or more resource elements of at least one resource block forming a resource block group allocated for the DMRS in the uplink signal or downlink signal.

2. The method as claimed in claim 1, comprising transmitting, by the base station (602), the downlink signal with the DMRS configured at the allocated position of the one or more resource elements.

3. The method as claimed in claim 1, comprising:
transmitting, by the base station (602), a UE enquiry signal; and
receiving, by the base station (602), a UE capability information signal comprising data on capabilities of the UE (604), wherein the one or more resource elements for the DMRS are allocated based on the capabilities of the UE (604).

4. The method as claimed in claim 1, wherein allocating the one or more resource elements for the DMRS comprises:
transmitting, by the base station (602), a Channel State Information-Reference Signal (CSI-RS) to the UE (604);
receiving, by the base station (602), a CSI report from the UE (604) in response to the CSI-RS; and
determining, by the base station (602), the condition of the channel based on at least the CSI report, wherein the one or more resource elements are allocated based on the condition of the channel.

5. The method as claimed in claim 1, comprising allocating, by the base station (602), a first set of resource elements in the downlink signal for the DMRS, wherein the indicator signal indicates positions of the first set of resource elements having the DMRS in the downlink signal.

6. The method as claimed in claim 1, comprising allocating, by the base station (602), a second set of resource elements in the uplink signal for the DMRS, wherein the indicator signal indicates positions of the second set of resource elements for the DMRS in the uplink signal from the UE (604).

7. The method as claimed in claim 6, comprising receiving, by the base station (602), the uplink signal from the UE (604) having the DMRS in the second set of resource elements.

8. The method as claimed in claim 1, wherein the indicator signal comprises any one or a combination of: the position of the one or more resource elements allocated for the DMRS in the downlink signal or the uplink signal, a number of the one or more resource elements allocated for the DMRS, a start position of the resource block, an end position of the resource block, and a frequency of the one or more resource elements.

9. The method as claimed in claim 1, comprising allocating, by the base station (602), based on an uplink threshold and a downlink threshold, one of:
one resource element of the at least one resource block for the DMRS in the downlink signal and the uplink signal when the condition of the channel is constant over a configured bandwidth;
two resource elements of the at least one resource block for the DMRS in the downlink signal and the uplink signal based on a change in the condition of the channel over the configured bandwidth;
one resource element of the at least one resource block for the DMRS in the downlink signal, and two resource elements of the at least one resource block for the DMRS for the uplink signal; or
two resource elements of the at least one resource block for the DMRS in the downlink signal and one resource element of the at least one resource block for the DMRS in the uplink signal.

10. The method as claimed in claim 1, comprising allocating, by the base station (602), the one or more resource elements in a frequency domain based on the condition of the channel, wherein allocating the one or more resource elements in the frequency domain comprises determining, by the base station (602), the position and a frequency of the one or more resource elements based on any one or a combination of: Channel Quality Indicator, Reference Signal Received Power (RSRP), Reference Signal Received Quality (RSRQ), signal-to-noise ratio, number of antenna ports associated with the base station, Hybrid Automatic Repeat Request (HARQ) feedback, cell throughput, and timing advance values transmitted to the UE (604) of a preceding time interval of a predetermined duration.

11. The method as claimed in claim 1, comprising allocating, by the base station (602), the one or more resource elements for the DMRS in the at least one resource block forming the resource block group, wherein a number of resource blocks in the resource block group is determined based on the condition of the channel.

12. The method as claimed in claim 1, wherein for non-contiguous physical uplink shared channel (PUSCH) allocation or physical downlink shared channel (PDSCH) allocation of the one or more resource elements for the DMRS, the method comprises transmitting, by the base station (602), at least one of:
a bitmap having one or more bits corresponding to the resource block group through the indicator signal, a value of each of the one or more bits in the bitmap indicating a presence of the DMRS in the resource block group; and
a position parameter that indicates the position of the DMRS within each resource block in the resource block group having the DMRS.

13. The method as claimed in claim 1, wherein for contiguous physical uplink shared channel (PUSCH) allocation or physical downlink shared channel (PDSCH) allocation of the one or more resource elements for the DMRS, the method comprises transmitting, by the base station (602), a start resource block in the resource block group, an end resource block in the resource block group, and a resource block frequency to indicate a location of the one or more resource elements having the DMRS.

14. The method as claimed in claim 1, comprising transmitting, by the base station (602), data or a null signal through a subset of resource elements from the one or more resource elements, based on at least one of: traffic load demand, channel conditions, and power constraints.

15. A method for dynamic Demodulation Reference Signal (DMRS) configuration, comprising:
determining, by a base station (602), a condition of a channel between the base station (602) and a User Equipment (UE) (604);
determining, by the base station (602), a number of time slots to be associated with each DMRS in an uplink signal or a downlink signal based on the condition of the channel;
transmitting, by the base station (602), an indicator signal to the UE (604) to indicate the number of time slots to be associated with each DMRS in the uplink signal or the downlink signal; and
transmitting, by the base station (602), the downlink signal to the UE (604) with a DMRS in one or more time slots equal to the determined number of time slots.

16. The method as claimed in claim 15, wherein transmitting, by the base station (602), the downlink signal to the UE (604) comprises:
allocating, by the base station (602), the DMRS in a first time slot in the one or more time slots; and
skipping, by the base station (602), allocation of the DMRS for subsequent time slots in the one or more time slots.

17. The method as claimed in claim 15, wherein determining, by the base station (602), the number of time slots to be associated with the DMRS comprises determining, by the base station (602), a time coherence value based on at least one of: a center frequency, time advance values in a predetermined preceding interval, and a Block Error Rate (BLER).

18. A user equipment (UE) (604), comprising:
a processor; and
a memory operatively coupled to the processor, wherein the memory comprises processor-executable instructions which, when executed by the processor, cause the processor to:
receive an indicator signal from a base station (602), wherein the indicator signal indicates one of: a position of one or more resource elements of at least one resource block forming a resource block group allocated for a Demodulation Reference Signal (DMRS) from a plurality of DMRS configuration types for a downlink signal or an uplink signal, or a total number of time slots to be associated with each DMRS in the downlink signal or the uplink signal, based on a condition of a channel between the UE (604) and the base station (602); and
transmit the uplink signal having the DMRS to the base station (602) based on the indicator signal.

19. The UE (604) as claimed in claim 18, wherein the indicator signal indicates the one or more resource elements allocated for the DMRS in the downlink signal or the uplink signal, based on a respective downlink threshold and an uplink threshold, from among one of:
one resource element of the at least one resource block for the DMRS in the downlink signal and the uplink signal when the condition of the channel is constant over a configured bandwidth;
two resource elements of the at least one resource block for the DMRS in the downlink signal and the uplink signal based on a change in the condition of the channel over the configured bandwidth exceeding a predetermined threshold;
one resource element of the at least one resource block for the DMRS in the downlink signal, and two resource elements of the at least one resource block for the DMRS for the uplink signal; or
two resource elements of the at least one resource block for the DMRS in the downlink signal and one resource element of the at least one resource block for the DMRS in the uplink signal.

20. The UE (604) as claimed in claim 18, wherein the memory comprises processor-executable instructions which, when executed by the processor, cause the processor to transmit data or a null signal through a subset of time slots from among the total number of time slots based on at least one of: traffic load demand, channel conditions, and power constraint.
